(19) United States
(12) Patent Application Publication
(10) Pub. No.: US 2013/0279202 A1
(43) Pub. Date: Oct. 24, 2013

(54) Efficient Side-Light Distribution System

(71) Applicant: Energy Focus. Inc., Solon, OH (US)

(72) Inventors: Gregory P. Frankiewicz, Mayfield Heights, OH (US); Roger F. Buelow, II, Gates Mills, OH (US); David Bina, Northfield Center, OH (US)

(21) Appl. No.: 13/657,531

(22) Filed: Oct. 22, 2012

Related U.S. Application Data
(60) Provisional application No. 61/549,796, filed on Oct. 21, 2011.

(51) Int. Cl. F21V 8/00

(52) U.S. Cl. CPC G02B 6/0001
USPC 362/618

(57) ABSTRACT

Improved side-light distribution systems are disclosed. One exemplary system includes a light source and a side-light distribution member. The light source supplies light to the side-light distribution member having (1) an net port on the first end of the member for receiving the light and (2) a second end having a reflective means. The inlet port consists of part of the surface area of the first end of the member. The reflective means associated with the second end of the member receives light from the first end and directs light towards the first end. At least part of a surface area of the first end of outside of the inlet port includes a reflective means for receiving the light from the second end and directing the light towards the second end of the rod.

### FIELD OF THE INVENTION

The present invention relates to a side-light distribution system and, in particular, to an efficient side-light distribution system having a size mismatch between an outlet port of a light source and an inlet port on a side-light distribution member.

### BACKGROUND OF THE INVENTION

A typical lighting system comprises a light source and an elongated side-light distribution member. A typical light source includes a light coupler governed by the laws of Etendue, to collect light emitted from a light emitter. The light source can comprise (1) at least one light emitting diode (LED), (2) a fiber optic system or (3) any other type of light emitter known to a person of ordinary skill in the art. In a typical system, light emitted from the light source is angularly transformed by the light coupler and directed toward a first end of a side-light distribution member. The coupled light is transported through the side-light distribution member by total internal reflection (TIR), and a portion of light is extracted in a desired direction or directions by light-extraction means on the side-light distribution member.

Some light is not extracted when it reaches the second end of the side-light distribution member. Typically, a reflective means is placed at the second end of the side-light distribution member to reflect the unextracted light back through the distribution member. Generally, the reflective means is oriented at an angle that is not orthogonal to a main direction of propagation of light along the side-light distribution member. This boosts the angle of the light traveling back in the side-light distribution member, thereby increasing the opportunity for extracting light on a second pass of light through the distribution member.

According to investigation by the present inventors, some portion of light reflected back from the second end of the side-light distribution member will again reach the first end of the side-light distribution member. Typically, an outlet port of the light coupler is sized to match the first end of the side-light distribution member. Typically, only about four percent of the light will be reflected back in the side-light distribution member due to Fresnel reflections. As discovered by the present inventors, the remaining light will couple into the light source and may be trapped or absorbed by the light source. The present inventors have determined that it is possible to make the side-light distribution member long enough so that the majority of light, reflected by the reflective means, is extracted on its way back into the distribution member. This minimizes the amount of light re-coupling into the coupling member. However, in practice it is not always practical to make a long side-light distribution member due to size or cost constraints.

The present inventors have determined that it would be desirable, for increasing the efficiency of the side-light distribution system, to reduce the amount of light, reflected back through the side-light distribution member by the reflective means at the second end of the distribution member, from becoming trapped or absorbed by the light source.

### SUMMARY OF THE INVENTION

A preferred embodiment of a side-light distribution system comprises a side-light distribution member having an elongated rod for receiving light from a light source and a second end. The elongated rod includes an elongated sidewall and a light-extraction means along at least part of the elongated sidewall for extracting light through the sidewall and distributing the light to one or more target areas. The light source supplies light to the rod through an inlet port on the first end of the rod; the inlet port consists of a part of the surface area of the first end of the rod. The second end of the rod has an associated reflective means which receives light for receiving light from the first end of the rod and for directing light towards the first end of the rod. At least part of the surface area of the first end outside of the inlet port includes a reflective means for receiving light from the second end of the rod and directing the foregoing light towards the second end of the rod.

Beneficially, the foregoing side-light distribution system enjoys increased efficiency by reducing trapping or absorption by the light source of light, reflected back through the side-light distribution member by the reflective means at the second end of the distribution member.

### BRIEF DESCRIPTION OF THE DRAWINGS

FIGS. 1 and 2 are identical side plan views of a prior art side-light distribution system, with respectively different light ray tracings investigated by the present inventors superposed thereon.

FIG. 3 is a side plan view of a side-light distribution system in accordance with one embodiment of the present invention.

FIG. 4 is an enlarged view of the left-shown end of the side-light distribution system of FIG. 3, with a portion removed to reveal cross-sectioned structures.

FIG. 5 is a simplified plan view of a first end of the side-light distribution system of FIG. 4 and associated reflective means, taken at the arrows marked FIG. 5 in FIG. 4.

FIG. 6 shows a simplified plan view of the first end of another side-light distribution system and reflective means, and is taken from the same perspective in relation to FIG. 7 as the end view in FIG. 5 is taken in relation to the side plan view of FIG. 4.

FIG. 7 shows a portion of a side-light distribution system having two light sources for providing light to a side-light distribution member.

### DETAILED DESCRIPTION OF THE INVENTION

The following detailed description will proceed with reference to a particular illustrated embodiment. However, the embodiment shown on the drawings is presented only as an example of the claimed subject matter, and should be considered not as limiting the scope of the invention.

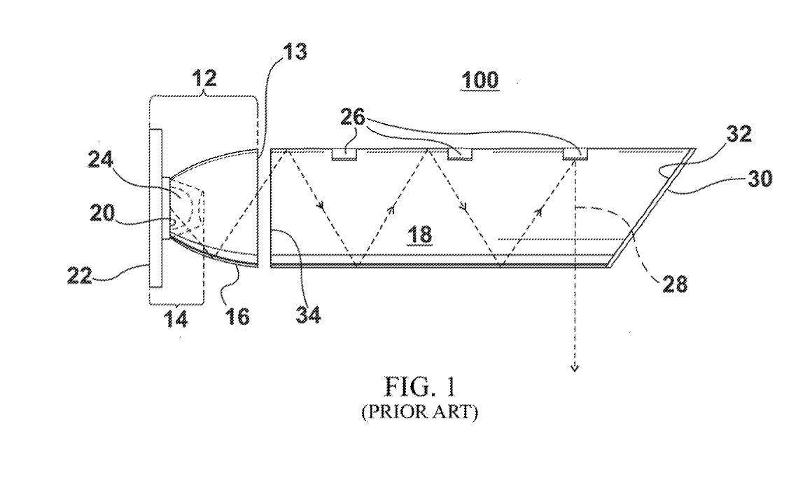

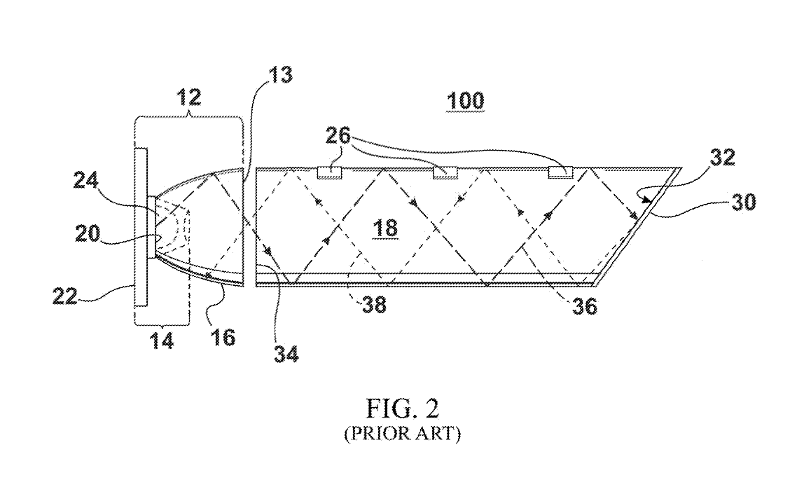

For the purpose of putting the present invention in perspective, prior art FIGS. 1 and 2 are first discussed. Prior art FIGS. 1 and 2 show the same side-light distribution system 100 in simplified form. System 100 includes a light source 12 that comprises a light emitter 14 and a light coupler 16, which couples light from the light emitter 14 to a side-light distribution member 18 via an outlet port 13 of the light coupler 16. The light emitter 14 can comprise, for instance, one or more light emitting diodes (LEDs) 20, a metal halide lamp, or any other form of suitable light emitter as will be apparent to a person of ordinary skill in the art.

The illustrated light emitter 14 comprises one or more LEDs 20 mounted on a support 22, such as a printed-circuit board, and a lens 24 for focusing light from the one or more LEDs 20.

The side-light distribution member 18 includes light-extraction means 26 for extracting light from the member 18, such as light ray 28 in FIG. 1. Light-extraction means 26 extracts and distributes the light from the side-light distribution member 18 in a direction that is generally perpendicular to the longitudinal axis of the side-light distribution member 18. This is shown by light ray 28 in FIG. 1 exiting the member 18 in a straight down direction.

Referring again to FIGS. 1 and 2, a reflective means 30 such as a mirror or other reflective material is applied to the right-shown second end 32 of side-light distribution member 18. A first end 34 of member 18 does not have a reflective means.

FIG. 2 illustrates a situation where some light originating from the light source 12 is not extracted from the side-light distribution member 18 by the light-extraction means 26. Thus, FIG. 2 shows a light ray 36 originating from the light source 12 and traveling left-to-right. Light ray 36 reaches reflector 30 at the second end of the side-light distribution member 18, and is reflected back to the left as light ray 38. As discovered by the present inventors, light ray 38 is representative of various light rays that are not extracted from member 18 by the light-extraction means 26, but instead passes back into light coupler 16. As further discovered by the present inventors, light ray 38 is highly susceptible to being wasted due to either (1) being scattered or absorbed by the light coupler 16, or (2) being absorbed by the light emitter 14.

Based on the foregoing investigations and discovery of the source of reduced light efficiency for the side-light distribution system 100 of FIGS. 1 and 2, the present inventors have devised a way to reduce the waste of light and thereby increase overall efficiency.

Reducing Waste of Light by Absorption in the Light Source

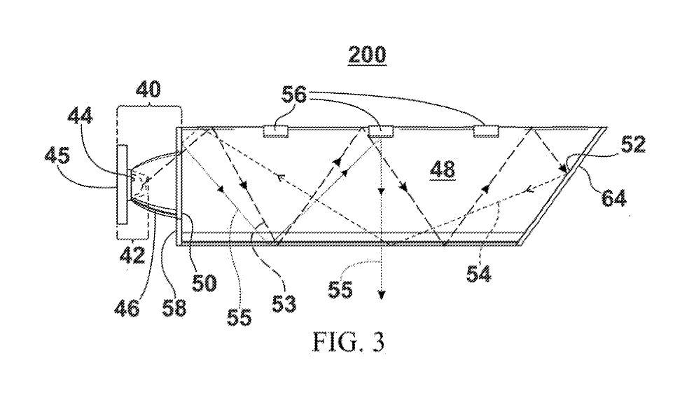

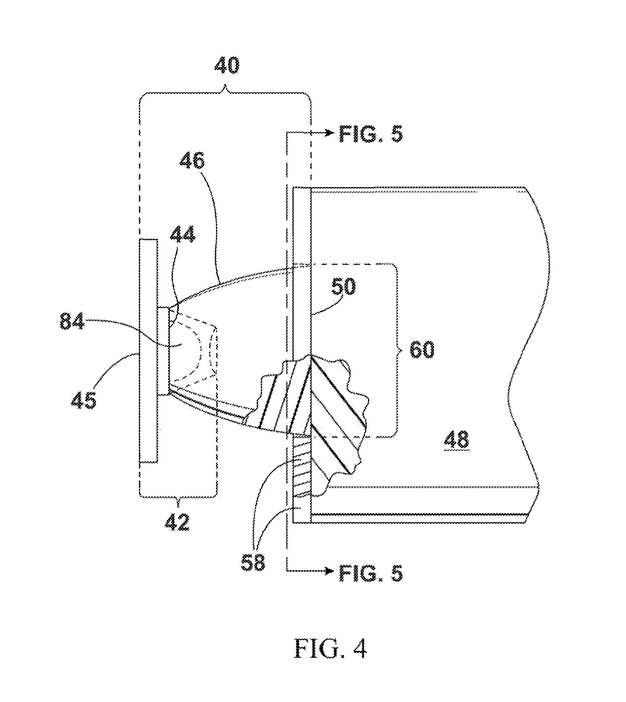

Thus, referring to FIGS. 3 and 4, showing a preferred embodiment of the claimed side-light distribution system, a light source 40 comprises (1) a light emitter 42 having one or more LEDs 44 mounted on a support 45, such as a printed-circuit board and a lens 84 for focusing light from the one or more LEDs 44 and (2) a light coupler 46.

The light coupler 46 angularly transforms the light received from the light emitter 42 and couples the light into a side-light distribution member 48. The light coupler 46 may be physically joined to side-light distribution member 48 such as with index-matching optical adhesive, or by being integrally and gaplessly joined together with homogeneous material, such as would result from being formed together in the same mold.

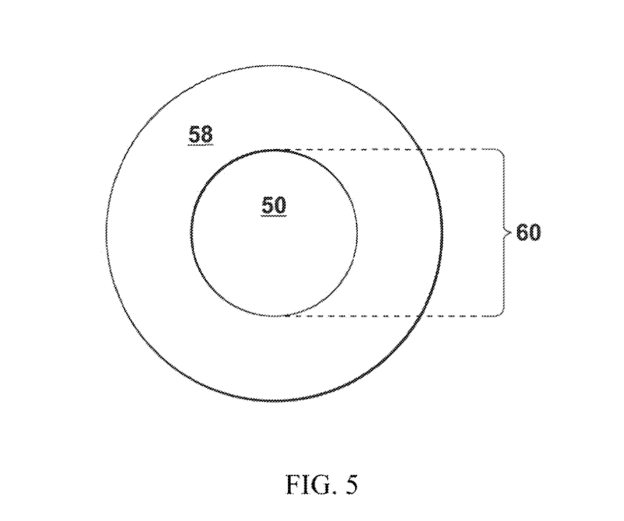

As shown by FIGS. 3 and 4, the size of the first end of the light coupler 46 is small relative to the size of the first end 50 of side-light distribution member 48. A reflective means 58, which may be in the form of an annular band as shown, is provided on a part of the first end 50 of the member 48. Reflective means 58 has a reflective surface facing into the side-light distribution member 48. In a preferred embodiment, reflective means 58 covers at least 50 percent of the surface area of first end 50. In another example, the reflective means covers at least 95 percent of the surface area of first end 50. Other variations in percentages for the reflective means can be readily selected by a person of ordinary skill in the art based on the present specification. In yet another preferred embodiment as shown in FIGS. 3-5, the reflective means 58 covers the entire surface area of the first end 50 outside of the inlet port of member 48 associated with bracket 60 (FIGS. 4 and 5).

As more clearly shown in enlarged FIG. 4, member 48 has a light inlet port bounded by bracket 60, which is coextensive with an outlet port of the light coupler 46, also bounded by bracket 60. The light inlet port on first end 50 is that part of the surface of the first end 50 that receives light from the light coupler 46. Preferably, the inlet port overlaps at least 90, and more preferably at least 95, percent of the outlet port of the light coupler 46.

In one example, the inlet port associated with bracket 60 (FIG. 4) of the first end 50 of the side-light distribution member 48 is less than 90 percent of the surface area of the first end 50 of member 46. In another example, the inlet port may be as small as practical, for instance, in one example, it may approximately as small as about one percent of the surface area of the first end 50. In other examples, the surface area percentage occupied by the inlet port of member 48 may be as low as about five percent or 10 percent or 20 percent or 30 percent or 40 percent or 50 percent of the surface area of the first end 50. In other examples, the surface area percentage occupied by the inlet port may be as low as about 60 percent or 70 percent or 80 percent of the surface area of the first end 50 of the side-light distribution member 48.

The inlet port associated with bracket 60 (FIGS. 4 and 5) may be centered on the first end 50 of the side-light distribution member 48, as shown in FIG. 5. As shown in FIG. 5, reflective means 58, in accordance with one example, surrounds the inlet port associated with bracket 60. Alternatively, though not shown, the inlet port may be positioned off center on the first end 50 of the rod. For example, relative to a longitudinal axis (not shown) of member 48, an outer edge of the outlet port of the light coupler 46 (FIG. 4) associated with bracket 60 may be tangent to an outer edge of the first end 50 of member 48. In this arrangement, an outer edge of the inlet port is also tangent to the outer edge of the first end 50. Beneficially, such an arrangement typically allows a more compact profile of the side-light distribution system, and may simplify inter-arrangement of the various parts of the side-light distribution system during manufacturing.

### Operation

Referring again to FIG. 3, in operation, light received by the first end 50 of the side-light distribution member 48 is transported towards the second end 52 of member 48, typically by totally internally reflecting on the sidewalls (e.g., top and bottom sidewalls) of member 48.

Light ray 53 does not strike light-extraction means 56 on its first transit from first end 50 to second end 52 of member 48. Rather, light ray 53 reaches, and is reflected back towards first end 50 as light ray 54, by reflective means 64, which is associated with the second end 52 of member 48, in order to redirect light back towards the first end 50. Reflective means 64 can be a reflective sticker or reflective paint applied to the second end 52, or a mirror. Other variations for a reflective means will be readily apparent to a person of ordinary skill in the art. In another embodiment, the reflective means 64 can be placed adjacent to the second and 52 of member 48. The particular light ray 54 beneficially reaches, and reflects from reflective means 58, so as to be directed towards the second end 52 of member 48 as light ray 55. Light ray 55 reflects from the bottom of member 48 so as to reach light-extraction means 56, from which it is directed, for instance, straight down and out the bottom side of member 48.

Referring to FIG. 3, the reflective means 58 applied on the first end 50 of member 48 receives some of the unextracted light (unnumbered) directed by the reflective means 64 on the second end 52 of member 48. With respect to the reflective means 58, persons of ordinary skill in the art typically cover a first end of a side-light distribution member with the outlet of a light source so that the member receives maximum light, and thus placing a reflective means 58 on the first end of member 48, as contemplated by the present inventors, would be counterintuitive for such persons of ordinary skill. Reflective means 58 also receives other light (not shown) scattered by various means within member 48 and directed towards the first end 50. Beneficially, the reflective means 68 reflects the impinging light back into side-light distribution member 48, increasing the chances of extracting light by the light-extraction means 56 when traveling again through the member 48. This results in increased efficiency of the claimed side-light distribution system.

FIG. 5 shows in simplified form a portion of the embodiment of FIGS. 3-4 in which the side-light distribution system 200 of these figures includes the side-light distribution member 48 (FIGS. 3-4) having the first end 50, the inlet port associated with bracket 60, and the reflective means 58 covering the entire surface area of the first end 50 outside of the inlet port of member 48 (FIGS. 3-4) associated with bracket 60.

### Multiple Light Sources

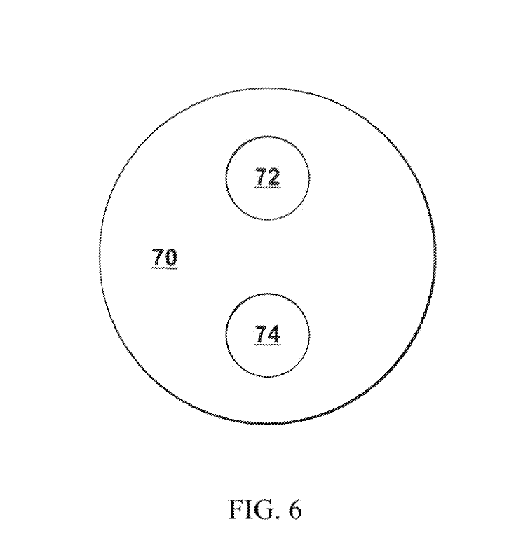

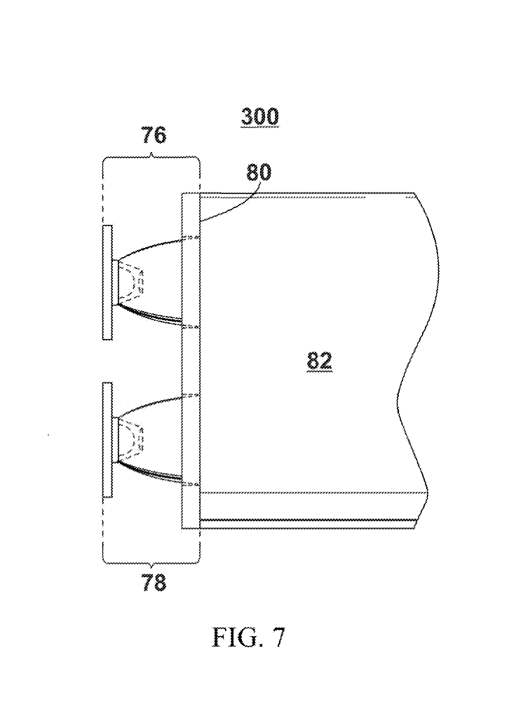

In contrast with FIG. 5, FIG. 6 shows in simplified form a portion of another embodiment in which a side-light distribution system includes a side-light distribution member having multiple, for example, two, inlet ports 72 and 74 for receiving light from two separate light sources. Thus, FIG. 7 shows a part of a side-light distribution system 300 having two light sources 76 and 78 for providing light to a first end 80 of a side-light distribution member 82. Light sources 76 and 78 may have the same construction as light source 40 of FIGS. 3 and 4. The omitted right-hand side of side-light distribution system 300 may have the same construction as the right-hand side of side-light distribution system 200 of FIG. 3.

The above description of the embodiment of FIGS. 3 and 4 also applies to the embodiment of FIGS. 6 and 7, except that the two inlet ports 72 and 74 of FIG. 6 substitute for the single inlet port associated with bracket 60 in FIGS. 4 and 5. Thus, for instance, the above description of the size of the foregoing single inlet port relative to the surface area of the first end 50 of side-light extraction member 48 applies to the embodiment of FIGS. 6 and 7, except that the aggregate area of the two inlet ports 72 and 74 (FIG. 6) substitutes for the area of the foregoing single inlet port.

Additional details of a light coupler, a side-light distribution member and light-extraction means are set forth below.

### Light Coupler

Light coupler 46 (FIG. 4) and the light couplers shown diagrammatically in light sources 76 and 78 of FIG. 7 preferably each has an interiorly-directed reflective means that receives light from a light emitter and transmits that light towards a respective “inlet port” of the side-light distribution member as that tem is used herein. The reflective means is typically specular if the light coupler is hollow, or of the TIR-type if the light coupler is solid (TIR meaning Total Internal reflection).

Typically, a light coupler, which may be at least approximately governed by the rules of non-imaging optics, has a profile that changes from the inlet end toward the outlet end to condition the angular distribution of light provided to a rod-shaped side-light distribution member. That is, as light propagates through the light coupler, its angular distribution changes. In addition, the interior surface of a solid light coupler may be configured to aid in the conditioning of light provided to a rod-shaped side-light distribution member.

An alternative to using light coupler 46 in FIGS. 3 and 4 is to supply light to side-light distribution member 48 by a fiberoptic cable or other light source, by way of example.

### Side-Light Distribution Member

The side-light distribution members 48 and 82 shown in FIGS. 3 and 7, respectively, preferably each comprises an elongated rod. By “elongated” it is meant being long in relation to width or diameter, for instance, where the “long” dimension can be both along a straight path or a curved path. The side-light distribution member may be made of an optically clear plastic material, such as polycarbonate or acrylic, or glass or any other suitable material known to a person of ordinary skill.

The elongated rod has an elongated sidewall and light-extraction means along at least part of the elongated sidewall for extracting light through the sidewall and distributing said light to a target area. At least, the part of the side-light distribution member having light-extraction means is preferably solid, although there may exist in the arrangement small voids caused by manufacturing processes, for instance, voids that have insubstantial impact on the side-light light-extraction and distribution properties of the side-light distribution member.

A side-light distribution member as used herein has a cross section along a main axis of light propagation through the rod that is more round than flat. For example, the minimum cross-sectional dimension is preferably more than 50 percent of the maximum cross-sectional dimension from (1) the first end 50 to a second end 52 of side-light distribution member 48, as shown in FIG. 3 and (2) from the first end 80 to a second end of side-light distribution member 82, as shown in FIG. 7. In a preferred embodiment, the cross-section of the side-light distribution member is substantially circular, but is not limited to such shape. Alternatively, the cross-section can be oval, half-round, square, rectangular, star-shaped, or have any other cross-sectional shapes readily apparent to a person of ordinary skill in the art.

Preferably, a side-light distribution member is rigid, by which is meant that at 20 degrees Celsius the arrangement has a self-supporting shape such that the side-light distribution member returns to its original or approximately original (e.g., linear or curved) shape after being bent along a main path of light propagation through the side-light distribution member.

The side-light distribution members 48 (FIGS. 3-4) and 82 (FIG. 7) may have a nearly constant cross-sectional area, as shown in FIG. 3 and FIG. 7, respectively, or may have a cross-sectional area that vanes (1) between the first end 50 and the second and 52 of such member 48 and (2) between the first end 80 and second end of member 82 respectively.

FIG. 3 also shows the light-extraction means 56 on side-light distribution member 48. Light-extraction means 56 and light-extraction means (not shown in the other embodiment of FIG. 7) are explained as follows.

### Light-Extraction Means

Light-extraction means may be of various types whose selection will be routine to those of ordinary skill in the art. For instance, three types of light-scattering means are disclosed in U.S. Pat. No. 7,163,326, entitled “Efficient Side-light Luminaire with Directional Side-Light-Extraction,” assigned to Energy Focus, Inc. of Solon, Ohio. In brief, these three types are (1) discontinuities on the surface of a side-light distribution member, (2) a layer of paint on the surface of a side-light distribution member, and (3) a vinyl sticker applied to the surface of a side-light distribution member.

In more detail, (1) discontinuities on the surface of a side-light distribution member may be formed, for instance, by creating a textured pattern on the side-light distribution member surface by molding, by roughening the side-light distribution member surface with chemical etchant, or by making one or more notches in the side of a side-light distribution member.

In another example, the light-extraction means may comprise a layer of paint exhibiting Lambertian-scattering and having a binder with a refractive index about the same as, or greater than that of, the core. Suitable light-extraction particles are added to the paint, such as titanium dioxide or many other materials as will be apparent to those of ordinary skill in the art. Preferably, the paint is an organic solvent-based paint.

In yet another example, the light-extraction means may comprise vinyl sticker material in a desired shape applied to the surface of the side-light distribution member. Appropriate vinyl stickers have been supplied by Avery Graphics, a division of Avery Dennison of Pasadena, Calif. The film is an adhesive white vinyl film of 0.146 mm, typically used for backlit signs.

In another example, the light-extraction means may be continuous, intermittent, or both, along the length of a side-light distribution member, for instance. An intermittent pattern is shown in the above-mentioned U.S. Pat. No. 7,163,326 in FIG. 15A, for instance. To assure that the light-extraction means appears as continuous from the point of view of the observer in a target area to be illuminated, the target area should be spaced from the side-light distribution member in the following manner: the spacing should be at least five times the length of the largest gaps between adjacent portions of paint or other light-extraction means along the main path of TIR light propagation through the side-light distribution member.

Additionally, the foregoing light-extraction patterns may be of the specular type, scattering type, or a combination of both. Generally, a scattering extractor pattern for light on an elongated side-light distribution member tends to provide light onto a target area, along the length of the side-light distribution member, with a moderate degree of directional control over the light in the length direction. In the direction orthogonal to the length, the scattering extractor pattern density and the cross sectional shape of the elongated side-light distribution member provide a smooth target distribution that is free of localized spatial structure but still provides good directional control. Scattering extractor patterns are relatively insensitive to fabrication errors.

In contrast, as used herein, a specular extraction pattern can provide light along the length of a side-light distribution member with more localized control than can a scattering extraction pattern.

In one example, the extraction means may also be a scattering or a specular paint or tape, in either a solid or generally chirped pattern with varying density. In another example, the extraction means may be a cut or a notch.

In another example, light-extraction means may have constant width but vary in density, where the light-extraction means may be denser farther away from the light source in another example, the light-extraction means may be not regularly spaced.

The following is a list of reference numerals and associated parts as used in this specification and drawings:

| Reference Numeral | Part |
|---|---|
| 12 | Light source |
| 13 | Outlet port |
| 14 | Light emitter |
| 16 | Light coupler |
| 18 | Side-light distribution member |
| 20 | One or more LEDs |
| 22 | Support |
| 24 | Lens |
| 26 | Light-extraction means |
| 28 | Light ray |
| 30 | Reflective means |
| 32 | Second end |
| 34 | First end |
| 36 | Light ray |
| 38 | Light ray |
| 40 | Light source |
| 42 | Light emitter |
| 44 | One or more LEDs |
| 45 | Support |
| 46 | Light coupler |
| 48 | Side-light distribution member |
| 50 | First end |
| 52 | Second end |
| 53 | Light ray |
| 54 | Light ray |
| 55 | Light ray |
| 56 | Light-extraction means |
| 58 | Reflective means |
| 60 | Bracket |
| 64 | Reflective means |
| 66 | Light ray |
| 70 | Reflective means |
| 72 | Inlet port |
| 74 | Inlet port |
| 76 | Light source |
| 78 | Light source |
| 80 | First end |
| 82 | Side-light distribution member |
| 84 | Lens |
| 100 | Side-light distribution system |
| 200 | Side-light distribution system |
| 300 | Side-light distribution system |

The terms “about” and “substantially” as used in the specification take into account manufacturing variations as understood by a person of ordinary skill in the art and, thus, the numerical percentages prefaced by the foregoing terms should be interpreted as including manufacturing variations.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An efficient side-light distribution system, comprising:
a) a side-light distribution member comprising an elongated rod having a first end for receiving light and a second end; the elongated rod comprising an elongated sidewall and light-extraction means along at least part of the elongated sidewall for extracting light through the sidewall and distributing said light to one or more target areas;
b) a reflective means associated with the second end of the rod for receiving light from the first end of the rod and directing said light towards the first end of the rod;
c) a light source supplying light to the rod through an inlet port on the first end of the rod; said port consisting of part of the surface area of the first end; and
d) at least part of the surface area of the first end outside of the port having a reflective means for receiving light from the second end of the rod and directing the foregoing light towards the second end of the rod.

2. The system of claim 1, wherein the inlet port consists of less than about 90 percent of the surface area of the first end.

3. The system of claim 1, wherein the reflective means associated with the first end of the rod covers at least about 50 percent of the surface of the first end other than the area covered by the inlet port.

4. The system of claim 1, wherein at least about 95 percent of the surface area of the first end outside of the inlet port has a reflective means for receiving light from the second end of the rod and directing the foregoing light towards the second end or the rod.

5. The system of claim 1, wherein the light source further comprises:
a) a light coupler having an interiorly-directed reflective means and having a profile that changes from an inlet port towards an outlet port to condition the angular distribution of light provided to the rod from said light source; and
b) the inlet port on the first end of the rod overlaps at least 90 percent of the outlet port of the light coupler of the light source.

6. The system of claim 1, wherein the inlet port on the first end of the rod overlaps at least 90 percent of the outlet port of the light source.

7. The system of claim 5, wherein the light source comprises a light-emitting diode.

8. The system of claim 1, wherein a minimum cross-sectional dimension of the rod is more than 50 percent of the maximum cross-sectional dimension of the rod along a main axis of light propagation from said first end to said second end.

9. The system of claim 1, further comprising a second light source supplying light to the rod through a second inlet port on the first end of the rod; said second inlet port consisting of part of the surface area of the first end other than the first inlet port.

10. The system of claim 10, wherein the second light source comprises a light emitting diode and a second light coupler having an interiorly-directed reflective means and having a profile that changes from an inlet port towards an outlet port to condition the angular distribution of light provided to the rod from said second light source.

11. The system of claim 2, wherein the inlet port occupies a range of between about five percent to about 80 percent of the surface area of the first end of the rod.

12. The system of claim 10, wherein the first and second inlet ports collectively occupy a range of between about one percent to about 80 percent of the surface area of the first end of the rod.

13. The system of claim 1, wherein the side-light distribution member comprises an acrylic rod.
